(19) United States
(12) Patent Application Publication
(10) Pub. No.: US 2017/0364486 A1
(43) Pub. Date: Dec. 21, 2017

(54) Precise Encoding and Direct Keyboard Entry of Chinese as Extension of Pinyin

(71) Applicant: Yan Zhou, Bothell, WA (US)

(72) Inventor: Yan Zhou, Bothell, WA (US)

(21) Appl. No.: 15/473,825

(22) Filed: Mar. 30, 2017

Related U.S. Application Data
(60) Provisional application No. 62/351,387, filed on Jun. 17, 2016.

(51) Int. Cl. G06F 17/22

(52) U.S. Cl. CPC G06F 17/2223

(57) ABSTRACT

Encoding Chinese in one(linear code)-to-one(character or word) correspondence systematically has been a century old challenge. Based on the official standards for Pinyin and writing order of characters, that all Chinese users are familiar with, this invention comprises: (1) encoding all characters and words of a predetermined set or dictionary into distinct codes in electronic system like computer; (2) retrieving character or word by decoding user's keyboard input, and then entering the corresponding character or word into the system. Denoted inside [ ], the proposed Pinyin+X coding format is [Pinyin+X]=[Pinyin]+[3-Stroke]+[Extra], where [3-Stroke] consists of three consonant letters coding for the first, second, and last stroke of the writing form of character or word, and [Extra] is system-generated consonant letter(s) to ensure the uniqueness of the entire [Pinyin+X] code. Pinyin+X keyboard entry process for Chinese can therefore be designed to be direct that every keystroke counts and none is extra.

### CROSS-REFERENCES TO RELATED APPLICATIONS

This is a non-provisional application for patent entitled to a filing date and claiming the benefit of the earlier-filed Provisional Application for Patent No, U.S. 62/351,387, filed on Jun. 17, 2016 under 37 CFR 1.53(c).

### BACKGROUND OF THE INVENTION

### 1. Field of the Invention

This invention relates to the keyboard entry process of single character and/or multi-character word into modern electronic system such as computer or smart phone. For people trained with Chinese writing system, they should be able to understand the encoding scheme and get used to the keyboard entry process with minimal additional training.

### 2. Description of the Related Practices

There have been many keyboard entry methods for Chinese characters and words, and one commonly used is Chinese (Simplified, China) Microsoft Pinyin in Windows. As a matter of fact, all keyboard entry methods currently used by public are one-to-many, which means that one code could correspond with many different characters or words. For instance, typing two keystrokes “yi” with Microsoft Pinyin will prompt the system to display hundreds of characters that are homophones like “1 [symbol] 2 [symbol] 3 [symbol] 4 [symbol] . . . 7 [symbol] ” in group of suggestion lists. Consequently, the user has to search for the desired character from the list and to make a manual selection by typing an extra keystroke like “2” for “ [symbol] ” or “7” for “ [symbol] ”. Such search and manual selection apparently interrupt the input process for Chinese; character-to-machine interaction has never been direct and accurate. In contrast, the input process for English is precise and straightforward, in the sense that neither search nor manual selection by extra keystroke is needed; whatever typed is exactly needed. Over the past century, there have been many attempts to achieve one(code)-to-one(character or word) correspondence for Chinese in simple, convenient, and systematical mechanism, but so far no success yet. The recent approaches by voice recognition and hand writing are difficult to maintain perfect accuracy consistently.

Chinese characters are manifested in two-dimensional graphic layouts. The order of strokes in writing character form does not matter and is never mandatory, as long as the ending graph is the same. For example, “ [symbol] ” can be written in the order of either “ [symbol] ” or “ [symbol] ”. On the other hand, electronic systems operate over one-dimensional signals like “0100101” or “abcde”. The incompatibility between non-linear characters and linear array of symbols has been one of the major challenges for Chinese people to communicate directly with modern electronic machines. This invention is a new attempt to resolve this issue by systematically and distinctively encoding Chinese characters and words with linear arrays of symbols. One of the applications of the precise linearization of Chinese is to enable people to input Chinese effectively and precisely with common keyboard.

### BRIEF SUMMARY OF THE PRESENT INVENTION

All proposed codes of this invention, like Pinyin codes, are denoted inside [ ]. The proposed Pinyin+X Encoding Scheme starts with [Pinyin] of a character or word, plus three consonant letters coding for the first, second, and last strokes of its writing form as [3-Stroke], plus an [Extra] if necessary for the entire code to be unique among a predetermined character and/or word set or dictionary. Extended after Pinyin, the final Pinyin+X code is in the format:

[Pinyin+X]=[Pinyin+Tone (optional)]+[3-Stroke]+[Extra (if necessary)],

or more generally, [Pinyin+X]=[Phonetic Part]+[Writing Form Identifier].

[Pinyin+Tone (optional)], as the [Phonetic Part], is solely responsible for the speech sound, and the rest as the [Writing Form Identifier] are assumed to carry no sound. As arrays of common symbols, the Pinyin+X codes are designed to have the following four features: (i) phonetic based as an extension of standard Pinyin (ISO-7098, 1982); (ii) being in one-to-one correspondence with different character and/or word; (iii) generated by algorithm for any given set of character and/or word; and (iv) implementable in any system by programming and maintained by the internal database.

Based on the internal database of the previously generated codes by Pinyin+X encoding scheme, when a user hits some keys, the system automatically checks if the accumulated keystrokes correspond to character(s) or word(s), and displays the matching result(s) if any. If the matching is unique, the user has the option to enter it directly into the system (by hitting “space bar” for example); if no, the user could hit additional key(s). Then the system checks the newly accumulated keystrokes again and display if matching character(s) or word(s) is found. This user-system interaction continues as the user hits more keys until a unique matching appears. In case that no single matching is found, which is very possible, the user could input whatever accumulated keystrokes into the system at any moment (by hitting “space bar” for example). The Pinyin+X keyboard input process for Chinese is similar to the one for English that no extra keystroke is needed and every single one is indispensable. The improvement over all other currently used, imprecise and indirect ways of inputting Chinese, including Microsoft Pinyin, will help people communicate with system effectively and increase productivity tremendously.

### BRIEF DESCRIPTION OF THE DRAWINGS

FIG. 1 Flowchart of Pinyin+X Encoding Scheme illustrates the programming logic of the precise encoding scheme for Chinese characters and words.

FIG. 2 Flowchart of Direct Keyboard Input for Character/Word illustrates the programming logic of the user interface for the direct keyboard entry process for Chinese.

### DETAILED DESCRIPTION OF THE INVENTION

Pinyin, short for Chinese Phonetic System ( [symbol] ), was adopted in 1958 by Chinese government and accepted as ISO-7098 in 1982 (Wei 2014: 250-252) to transcribe the speech sound of characters with common symbols. The ending of Pinyin is marked only by vowels “a, e, i, o, ü”, or the consonants “n”, “ng”, “r”, or sometimes unofficially “v” for “ü”. It is therefore easy for people familiar with the Pinyin to identify the end of [Pinyin]. The diacritic mark above the vowel in Pinyin notation for speech tone is often omitted for convenience of easy reading and writing in practical life; for example, [yi] could be denoted simply as [yi]. The official Pinyins of characters and words are specified in modern Chinese dictionaries.

Character forms are composed of about 30 character strokes, which are grouped into five basic strokes: “ [symbol] ”, “ [symbol] ”, “ [symbol] ”, “ [symbol] “, and” [symbol] ”. The standard writing orders in these five basic strokes for 20,902 characters in official set GB13000.1-1993 (State Bureau of Technical Supervision 1993) are specified in regulations GF 3002-1999, GF 3003-1999, and GF 2001-2001 (State Language Commission 1999a, 1999b, and 2001 respectively). The official Pinyin and writing order of characters can also be obtained easily from online reference sites such as http://baike.baidu.com (Baidu Encyclopedia) and http://www.zdic.net. In daily life, people generally follow those writing orders, which are nevertheless never strictly enforced.

With few exceptions, almost all single characters are also Chinese words standing alone. A multi-character or compound word is an array of characters as a linguistic unit that together has a distinct meaning. From the structural point of view, a compound word is basically the expansion of one character to the extent that the compound's speech sound consists of the array of the syllables of its constituent characters and the compound's writing form the array of the writing forms of the constituents. Consequently, the standard writing order of compound word is simply the concatenation of the standard writing orders of the constituent characters. Single character and compound word are basically treated as the same in encoding and decoding.

There have been various sets of characters and words, such as 20,902 characters compiled in GB13000.1-1993, or 13,000 characters plus 69,000 words in Modern Chinese Dictionary (Jiang et al 2012). While examining and generating the unique codes for characters and words (as described in the following), a predetermined set or dictionary is always presupposed for reference.

TABLE 1 Pinyin+X Coding Chart (shown below) contains all codes or common symbols used for the Pinyin+X encoding scheme, including vowels and consonant letters of standard Pinyin. Non-ending consonants are consonant letters used only before vowels, not as the ending of Pinyin. Therefore they can be used for coding basic strokes or as extra endings to be amended after Pinyin and are supposed to be silent or “no-sounding” after the Pinyin vowel(s).

TABLE 1
Pinyin + X Coding Chart

| | | | For [Pinyin] | | For [3-Stroke] | | For [Extra] |
|---|---|---|---|---|---|---|---|
| Common | | Ending | Non-ending | (Optional) | | No-sounding | No-sounding |
| Symbol | Vowel | Consonant | Consonant | Tone Code | Stroke | Stroke Code | Extra Ending |
| a | a | | | | | | |
| b | | | b | | | | b |
| c | | | c | | | | c |
| d | | | d | | [symbol] | d | |
| e | e | | | | | | |
| f | | | f | | | | f |
| g | | [symbol] | | | | | |
| h | | | h | | [symbol] | h | |
| i | i | | | | | | |
| j | | | j | | | | j |
| k | | | k | | | | k |
| l | | | l | | | | l |
| m | | | m | | | | m |
| n | | n | | | | | |
| o | o | | | | | | |
| p | | | p | | [symbol] | p | |
| q | | | q | | | | q |
| r | | r | | | | | |
| s | | | s | | [symbol] | s | |
| t | | | t | | | | t |
| u | u | | | | | | |
| v | | v | | | | | |
| w | | | | | | | |
| x | | | x | | | | x |
| y | | | | | | | |
| z | | | z | | [symbol] | z | |
| 1 | | | | 1 (flat [symbol] ) | | | |
| 2 | | | | 2 (rising [symbol] ) | | | |
| 3 | | | | 3 (falling-rising [symbol] ) | | | |
| 4 | | | | 4 (falling [symbol] ) | | | |
| 0 | | | | 0 (soft [symbol] ) | | | |

There are four major speech tones in standard Chinese: flat ( [symbol] ), rising ( [symbol] ), falling-rising ( [symbol] ), falling ( [symbol] ), plus the rarely used soft ( [symbol] ). These five tones can be denoted as “1”, “2”, “3”, “4”, and “0” respectively after the ending of regular Pinyin to replace the diacritic tone marks; e.g. [yi] could be written as [yi3]. In this manner, the numeric sign for tone not only marks the ending of regular Pinyin, but also indicates that the particular array of symbols is Chinese spelling, not for English or other language. As the diacritic tone mark for Pinyin is often neglected in practice, the numerical sign for speech tone could be omitted as well.

The five basic strokes, “ [symbol] ”, “ [symbol] ”, “ [symbol] ”, “ [symbol] ” and “ [symbol] ”, will be denoted by five consonant letters “h”, “s”, “p”, “d”, and “z”, called stroke codes, which are the initials of their Chinese stroke names in Pinyin, [héng] ( [symbol] ), [shù] ( [symbol] ), [piē] ( [symbol] ), [di\check{a}n] ( [symbol] ), and [zhē] ( [symbol] ), respectively, for easy memory.

Consonant letters “b, c, f, j, k, l, m, q, t, x” are reserved as [Extra] code to be used as the final extra-ending after Pinyin and stroke codes if needed to achieve the uniqueness of the entire combined code (to be explained later) for a character or word. In fact, there are indefinitely many combinations of them such as “bb, bc, . . . , bx; cb, cc, . . . ” that can also be used as the [Extra] endings if needed. The mechanism of amending different [Extra] ending(s) to achieve the uniqueness should work for the coding of indefinitely many characters and words. In practice, as shown in the following examples, the initial ten [Extra] codes are usually sufficient.

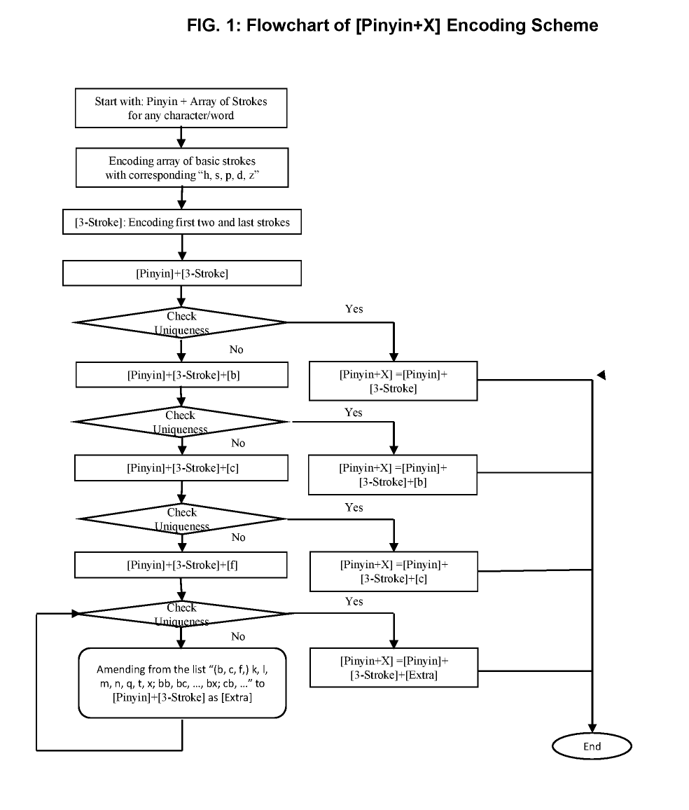

FIG. 1 Flowchart of Pinyin+X Encoding Scheme illustrates the programming logic for the systematical generation of distinct Pinyin+X codes for all predetermined characters and/or words. The flowchart starts with standard [Pinyin] and writing order in basic strokes, both of which are officially mandated and supposedly known to Chinese users. [3-Stroke] encodes the first, second, and last strokes of the writing form with three of the stroke codes “h, s, p, d, z” corresponding to “ [symbol] ” respectively. The combined [Pinyin]+[3-Stroke] code depends entirely on individual character or word, namely, on its standard speech sound and writing order of strokes.

Simply put, the programming logic for uniqueness is straightforward: first check if [Pinyin]+[3-Stroke] is distinct; if not, try one [Extra] ending after it and again check if the newly amended code is distinct; if not, try a different [Extra] ending after the same [Pinyin]+[3-Stroke] to see if the newly amended code is distinct. Continuing the examination and trial of distinct [Extra] ending(s) will eventually arrive at the uniqueness for all, as the available extra endings are theoretically unlimited. Practically only few are usually enough as shown by the examples.

More details are following. Let system check if the code [Pinyin]+[3-Stroke] is unique. If it is unique, the final [Pinyin+X]=[Pinyin]+[3-Stroke]; if there are duplicates, amend “b” to all those duplicated [Pinyin]+[3-Stroke]s, and then check if the newly amended [Pinyin]+[3-Stroke]+[b] is unique. If unique, the final [Pinyin+X]=[Pinyin]+[3-Stroke]+[b]; if there are duplicates again, amend “c” to only those [Pinyin]+[3-Stroke]s whose amended [Pinyin]+[3-Stroke]+[b]s are duplicated, and then check if the newly amended [Pinyin]+[3-Stroke]+[c] is unique. If unique, the final [Pinyin+X]=[Pinyin]+[3-Stroke]+[c]; otherwise, continue to amend “f”, “j”, etc. as the [Extra] ending until the final [Pinyin+X]=[Pinyin]+[3-Stroke]+[Extra] is unique. The algorithm can be illustrated with the sample characters and words below.

TABLE 2: Pinyin+X Codes for Characters with [yi] Syllable Sound with Tone (attached at the end) contains a sample set of 77 homophone characters with the same Pinyin [yi] while the speech tone is considered, and the calculations on Microsoft Excel sheet for their distinct Pinyin+X codes. Columns “Character”, “Pinyin” with tone, and “Strokes in Order” are standard for character users. The column “3-Stroke” contains the [3-Stroke] codes based on the first, second, and last strokes of character writing order. The combined [Pinyin]+[3-Stroke] codes are in column “Pinyin+3S”. The column “Duplicate” displays the results of the checking the uniqueness of the codes in “Pinyin+3S”, where “#N/A” indicates being distinct. As some codes in “Pinyin+3S” are duplicated, “b” is amended to only those duplicated [Pinyin]+[3-Stroke]s to be listed under “Extra-b”; for those in “Pinyin+3S” being unique already, they remain in “Extra-b”. Therefore, “Extra-b” comprises [Pinyin]+[3-Stroke]+[b] or [Pinyin]+[3-Stroke]. Next, “Duplicate-b” displays the result of the checking the uniqueness of the codes in column “Extra-b”. If some in “Extra-b” are duplicated, “c” is amended to only those [Pinyin]+[3-Stroke] whose corresponding codes in “Extra-b” are duplicated to be listed under “Extra-c”; for those in “Extra-b” being unique already, they remain in “Extra-c”. Therefore, “Extra-c” comprises [Pinyin]+[3-Stroke]+[c], [Pinyin]+[3-Stroke]+[b], or [Pinyin]+[3-Stroke]. After extra “f” is amended in this example, all [Pinyin]+[3-Stroke]+[Extra] codes are distinct, and therefore the final [Pinyin+X] codes are in the last column “Extra-f” of adjusted codes. For a character “ [symbol] ”, its Pinyin is [yi4] with tone, the standard writing order is “ [symbol] [symbol] ”, the [3-stroke]=[zdd], and the [Pinyin]+[3-Stroke]=[yi4zdd], which is unique and hence the final Pinyin+X code remained in the column “Extra-f”. The column “Duplicate-f” to check the duplicates in “Extra-f” is hidden to save space.

TABLE 3: Pinyin+X Codes for Characters with [yi] Syllable Sound without Tone (attached at the end) contains the calculations on Microsoft Excel sheet of the distinct Pinyin+X codes for all 77 homophone characters in the same sample set as in TABLE 2 while the speech tone is neglected. The columns “Character”, “Pinyin” without tone, and “Strokes in Order” are standard. The same algorithm continues till extra “j” being amended after [Pinyin]+[3-Stroke] to achieve the uniqueness for all; and the final distinct [Pinyin+X] codes remain in the last column “Extra-j” of adjusted codes. It is expected that more duplicates appear and hence more extra-endings are needed in case that Pinyin tone is neglected. For the same character “ [symbol] ”, its Pinyin is [yi] without tone, and the [Pinyin]+[3-Stroke]=[yizdd], which is the second duplicate and hence amended with “c”, and therefore its final [Pinyin+X]=[yizddc] remained in the last column “Extra-j” of adjusted codes. Note that “ [symbol] ” is the first character having [yizdd] and “ [symbol] ” is the first duplicate; Pinyin+X code for “ [symbol] ” is the original [yizdd], and for “ [symbol] ” is [yizddb] being adjusted with the extra ending “b”. Columns “Duplicate-c”, “Duplicate-f”, and “Duplicate-j” to check the duplicates are hidden to save space.

TABLE 4: Pinyin+X Codes for Words with [yiyi] Speech Sound without Tone (attached at the end) contains a sample set of 22 two-character homophone words with the same Pinyin [yiyi] while the speech tone is neglected, and the calculations on Microsoft Excel sheet for their distinct Pinyin+X codes. Column “2-Ch Word” includes two-character compound words, and columns “Ch-1” and “Ch-2” contain the first and second character separated, both of which are contained in TABLE 3. Each compound's [Pinyin] is the concatenation of the constituents' Pinyins, and its [3-Stroke] code depends on the first, second, and last strokes of the compound's writing form, which are basically the first and second strokes of the first character and the last stroke of the last character of the compound, as the compound's writing form is the concatenation of the constituents' forms. Compounds' [Pinyin]+[3-Stroke] are listed in the column “Pinyin+3S”. The same algorithm continues till extra “f” being amended after [Pinyin]+[3-Stroke] to achieve the uniqueness for all; the final [Pinyin+X] codes remain in the last column “Extra-j” of adjusted codes. For 2-Character word “ [symbol] ”, for example, it is the compound of “ [symbol] ” and “ [symbol] ”. Based on the standard Pinyins and writing orders of “ [symbol] ” and “ [symbol] ” from TABLE 3, its [Pinyin]+[3-Stroke]=[yiyidhd], which is the third duplicate and hence amended with “f” to arrive at its final [Pinyin+X]=[yiyidhdf] in the column “Extra-f”. Note that “ [symbol] ” is the first word with the original code [yiyidhd], and “ [symbol] ” the first duplicate with the adjusted code [yiyidhdb], and “ [symbol] [symbol] ” the second with [yiyidhdc].

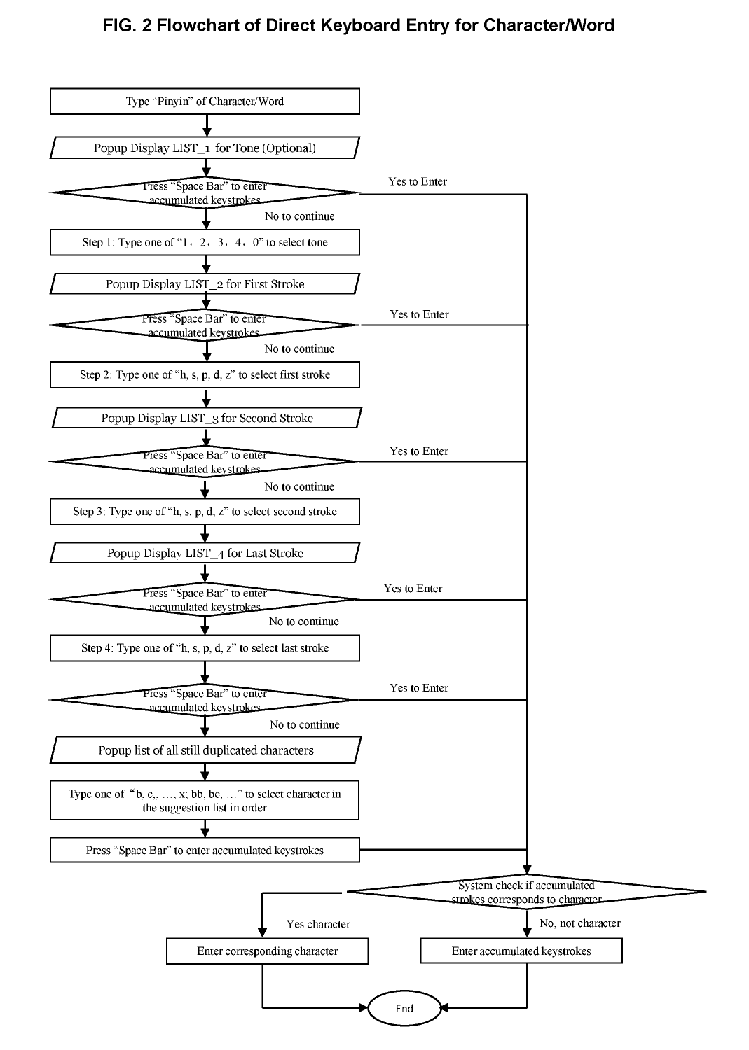

FIG. 2 Flowchart of Direct Keyboard Input for Character/Word illustrates the programming logic for the direct keyboard entry of Chinese. Assume all characters and words of a predetermined set, e.g. Modern Chinese Dictionary (Jiang et al. 2012), are Pinyin+X encoded distinctively and saved in an internal database, like TABLE 2, based on which any system such as Microsoft Windows can check if accumulated keystrokes correspond to a character or word. The proposed user interface for inputting Chinese could be similar to that of the current Chinese (Simplified, China) Microsoft Pinyin. Similar to the automatic display of homophone characters or words, e.g. “ [symbol] ”, after typing one Pinyin “yi” in Microsoft Windows, suggestion lists for homophone character or word in the proposed setting will also display in the following steps—choosing speech tone (optional), and the first, second, last stroke, and possible duplicates. The speech tone (optional) could be omitted as often being the case in practice for convenience. Since Chinese users are supposed to know the Pinyin, tone, and writing order of their intended character or word, they should have no problem to type the codes for the tone (optional) and first, second, and last strokes directly without even looking at the suggestion list. If the users remember extra-ending codes “b, c, f, j, k, l, m, q, t, x; bb, bc, . . . ,” in case that duplicates do occur in the last step, they can choose for the desired character or word by typing the extra code directly again without even looking at the suggestion list. If the accumulated keystrokes do not correspond to any character or word, that is, there is no return from database query based on the keys typed, users can input whatever accumulated keystrokes into the system. This user-system interaction can be programmed with the example below:

Begin the proposed Pinyin+X Keyboard Entry Process by typing Pinyin “yi”, using the sample character set and Pinyin+X codes of TABLE 2.

Let the system perform the following five queries:
SQL_1: select character from TABLE 2 where Pinyin+X=[yi1*]
SQL_2: select character from TABLE 2 where Pinyin+X=[yi2*]
. . .
SQL_0: select character from TABLE 2 where Pinyin+X=[yi0*]

Here “*” represents any symbol or set of symbols; therefore, yi1*] includes all [yi1], [yi1h], [yi1psp], [yi1dds], etc., for example.

Let CH_1 be the list of characters as the result of SQL_1, CH_2 of SQL 2, . . . , and CH_0 of SQL_0, respectively. Since SQL_0 returns nothing, CH_0 is empty. For example, CH_1={ [symbol] [symbol] } based on TABLE 2. The first automatic suggestion list will display for the next selection:

LIST_1: “Tone: 1 CH_1, 2 CH_2, 3 CH_3, 4 CH_4”.

Step 1: type number for speech tone (one of “1, 2, 3, 4, 0” corresponding to the tone of the character after “yi”). Type “1”, for example, and have keystrokes accumulated as “yi1”. Then next two choices for user are either pressing “Space Bar”, which prompts the system to enter “yi1” as is (because of no corresponding character in TABLE 2), or continuing without pressing “Space Bar”.

Let the system perform the following five more queries:
SQL_1d: select character from TABLE 2 where Pinyin+X=[yi1d*]
SQL_1h: select character from TABLE 2 where Pinyin+X=[yi1h*]
. . .
SQL_1z: select character from TABLE 2 where Pinyin+X=[yi1z*]

Let CH_1d be the list of characters as the result of SQL_1d, CH_1h of SQL_1h, . . . , and CH_1z of SQL_1z, respectively. Because SQL_1s and SQL_1z return nothing, CH_1s and CH_1z are empty. The second suggestion list will display:

LIST_2: “1^{st} Stroke: d CH_1d, h CH_1h, p CH_1p”.

For instance, CH_1h={ [symbol] } because their codes are [yi1h], [yi1hdz], [yi1hsh], and [yi1hshb] respectively.

Step 2: type letter for the first stroke (one of “d, h, p, s, z” corresponding to the first stroke of the character after “yi1”). Type “h”, for example, and have keystrokes accumulated as “yi1h”. Then next two choices for user are either pressing “Space Bar”, which prompts the system to enter “ [symbol] ” (that corresponds to [yi1h] in TABLE 2), or continuing without pressing “Space Bar”.

Let the system perform another five queries:
SQL_1hd: select character from TABLE 2 where Pinyin+X=[yi1hd*]
. . .
SQL_1hs=select character from TABLE 2 where Pinyin+X=[yi1hs*]
SQL_1hz: select character from TABLE 2 where Pinyin+X=[yi1hz*]

Let CH_1hd, . . . , CH_1hz be the sets of returning characters from the queries respectively. Because of no return from SQL_1hh, SQL_1hd, and SQL_1hz, three sets CH_1hh, CH_1hd, and CH_1hz are empty. The suggestion list will display:

LIST_3: “2^{nd} Stroke: p CH_1hp, s CH_1hs”.

Now CH_1hs={ [symbol] } as their codes are [yi1hsh] and [yi1hshb] respectively.

Step 3: type letter for the second stroke (one of “d, h, p, s, z” corresponding to the second stroke after “yi1h”). Type “s”, for example, and have keystrokes accumulated as “yi1hs”. Then next two choices for user are either pressing “Space Bar”, which prompts the system to enter “yi1hs” (because of no corresponding character), or continuing without pressing “Space Bar”.

Let the system perform another five queries:
SQL_1hsd: select character from TABLE 2 where Pinyin+X=[yi1hsd*]
SQL_1hsh: select character from TABLE 2 where Pinyin+X=[yi1hsh*]
. . .
SQL_1hsz: select character from TABLE 2 where Pinyin+X=[yi1hsz*]

Let CH_1hsd, . . . , CH_1hsz be the sets of returning characters from the queries respectively. Since there is no return from all except SQL_1hsh, the suggestion list will display:

LIST_4: “Last Stroke: h CH_1hsh”.

CH_1hsh={ [symbol] }, which remains the same as the previous CH_1hs. Note that [yi1hshb] for the second “ [symbol] ” is the [yi1hsh] for the first “ [symbol] ” amended with extra [b].

Step 4: type letter for the last stroke (one of “d, h, p, s, z” corresponding to the last stroke after “yi1hs”). Typing “h”, for example, and having keystrokes accumulated as “yi1hsh” prompt the system to display the last suggestion list CH_1hsh={ [symbol] } that has one duplicate. Then the user has two choices: either press “Space Bar” that prompts the system to enter “ [symbol] ” corresponding to [yi1hsh], or type additional “b” and then press “Space Bar” that prompt the system to enter “ [symbol] ” corresponding to [yi1hshb] in case that the user knows the characters in the suggestion list are in the order of having none extra ending first and then extra-ending code from “b, c, f, j, k, l, m, q, t, x; bb, bc, . . . ” consecutively. If the user does not know which character corresponds to what extra ending code after [yi1hsh], just select or highlight the desired one from the suggestion list and press “Space Bar” to enter that character. The process ends.

Here are some notes about the display of suggestion list that are system generated. After typing Pinyin [yi] with the current Chinese (Simplified, China) Microsoft Pinyin, the Microsoft Windows will display hundreds of homophone characters like “ [symbol] 1 [symbol] 2 [symbol] 3 [symbol] 4 [symbol] . . . 7 [symbol] ” in many smaller groups. Arrow sign “<” or “>” is used to navigate to the previous or next group respectively. This same Microsoft setting could be used in this keyboard input process. Because of the additional filtering capability, the suggestion lists in this process will get shorter quickly after each step till the last one with a number of duplicates, or a unique character or word if luckily been unique. The last suggestion list may contain one character or word corresponding to the accumulated keystrokes, or multiple ones, or none. In case of no result from the database query based on the accumulated keystrokes in any step, there would be no suggestion list to display. Final important remark regarding the practical implementation: Chinese users do not need the suggestion lists in this process in general, since they are supposed to know the standard Pinyin, and the first, second, and last strokes of character and word; the only additional requirements for them are to remember and get used to five tone codes (optional), five stroke codes, and ten extra-ending codes to distinct the duplicates in case needed.

### OTHER REFERENCES

Jiang, Lansheng [symbol] Tang, Jinchun [symbol] , and Cheng, Rong [symbol] 2012. Xiandai Hanyu Cidian, 6 Ban [symbol] 6 [symbol] (Modern Chinese Dictionary, 6^{th} Ed) [symbol] (Beijing: The Commercial Press)
State Bureau of Technical Supervision [symbol] 1993. GB13000.1-93 Xinxi Jishu Tongyong Duobawei Bianma Zifuji [symbol] [symbol] (Universal Multiple-Octet Coded Character Set GB13000.1 for Information Technology). [symbol] [symbol] (Beijing: China Standards Press)
State Language Commission [symbol] 1999a. GF3002-1999, GB13000.1 Zifuji Hanzi Bishun Guifan [symbol] [symbol] (Regulation on Writing Order of Strokes for GB13000.1 Character Set). [symbol] [symbol] (Shanghai: Shanghai Education Press)
State Language Commission [symbol] 1999b. GF3003-1999, GB13000.1 Zifuji Hanzi Zixu (Bihuaxu) Guifan [symbol] ( [symbol] ) [symbol] (Regulation on Character Order (Stroke Order) for GB13000.1 Character Set). [symbol] [symbol] (Shanghai: Shanghai Education Press)
State Language Commission [symbol] 2001. GF2001-2001, GB13000.1 Zifuji Hanzi Zebi Guifan [symbol] [symbol] (Regulation on Corning Strokes for GB13000.1 Character Set). [symbol] [symbol] (Beijing: Language and Culture Press)
Wei, Li [symbol] 2014. Yuyan Wenzi Guifan Shouce [symbol] [symbol] (Regulation Handbook of Language and Character). [symbol] (Beijing: The Commercial Press)

Having described my invention, I have the following claims:

1. The design of [Writing Form Identifier] as the extension of standard Pinyin to make Pinyin+X code in the format of [Pinyin]+[Writing Form Identifier] for all Chinese characters and words of a predetermined set in one(code)-to-one(character/word) correspondence, wherein [Pinyin] is solely responsible for the speech sound and [Writing Form Identifier] comprises consonant letters/codes only and reveals no sound to describe the writing form.

2. The design of [Writing Form Identifier] of claim 1 in the format of [3-Stroke]+[Extra], so that the final [Pinyin+X]=[Pinyin]+[3-Stroke]+[Extra].

3. The design of [3-Stroke] of claim 2, coding for the first, second, and last stroke of the standard writing order of character/word form, based on a stroke coding schedule for five basic strokes, “ [symbol] ”, “ [symbol] ”, “ [symbol] ”, “ [symbol] ”, and “ [symbol] ” using five consonant letters that are not used after vowel letter(s) in standard Pinyin.

4. The design of [Extra] of claim 2, using single consonant letters that are not used after the vowel letter(s) in standard Pinyin, or their indefinite combinations.

5. The algorithm of generating and amending [Extra] of claim 2 after [Pinyin]+[3-Stroke] to arrive at unique [Pinyin]+[3-Stroke]+[Extra] recursively and consecutively.

6. As part of claim 5, checking the uniqueness of [Pinyin]+[3-Stroke] and [Pinyin]+[3-Stroke]+[Extra (if added)] against all existing codes.

7. As part of claim 5, [Pinyin]+[3-Stroke] or [Pinyin]+[3-Stroke]+[Extra (if added)] retained as the final Pinyin+X code if it is unique.

8. As part of claim 5, amending a different [(new) Extra] after [Pinyin]+[3-Stroke] if [Pinyin]+[3-Stroke]+[(old) Extra] is duplicated, and then going back to the step of checking the uniqueness of [Pinyin]+[3-Stroke]+[(new) Extra], etc., recursively till all final Pinyin+X codes are unique.
